(19) United States
(12) Patent Application Publication
(10) Pub. No.: US 2026/0087859 A1
(43) Pub. Date: Mar. 26, 2026

(54) PERFORMANCE-BASED MODEL RE-SELECTION

(71) Applicant: International Business Machines Corporation, Armonk, NY (US)

(72) Inventors: Laura WYNTER, Singapore (SG); Rhui Dih LEE, Singapore (SG); Luis Angel BATHEN, San Jose, CA (US)

(21) Appl. No.: 18/895,235

(22) Filed: Sep. 24, 2024

(51) Int. Cl. G07C 5/00; B60W 50/06

(52) U.S. Cl. CPC G07C 5/008; B60W 50/06

(57) ABSTRACT

In some implementations, a device may receive a set of selectable artificial intelligence (AI) or machine learning (ML) models (AI/ML models) associated with an operation of a device, the selectable AI/ML models having different sizes and being trained to provide assistance in the operation; applying, in association with performance of the operation, a first AI/ML model of the set of selectable AI/ML models; and applying, in association with performance of the operation and based at least in part on performance of the first AI/ML model, a second AI/ML model of the set of selectable AI/ML models.

### BACKGROUND

Automated driving (AD) includes autonomous, semi-autonomous, and assisted driving, and technical capabilities required for enabling these. Artificial intelligence (AI) or machine learning (ML) models (collectively, AI/ML models) may be used for tasks in automated driving. For example, AI/ML models may include traffic lane identification, assisted or automated braking, pedestrian or other obstruction detection, or control (e.g., steering or navigation) of the vehicle itself in a road environment.

### SUMMARY

In some implementations, a method comprises receiving a set of selectable artificial intelligence (AI) or machine learning (ML) models (AI/ML models) associated with an operation of a device, the selectable AI/ML models having different sizes and being trained to provide assistance in the operation. The method further comprises applying, in association with performance of the operation, a first AI/ML model of the set of selectable AI/ML models. The method further comprises applying, in association with performance of the operation and based at least in part on performance of the first AI/ML model, a second AI/ML model of the set of selectable AI/ML models.

In some implementations, a computer program product comprises one or more computer readable storage media, and program instructions collectively stored on the one or more computer readable storage media. The program instructions comprise program instructions to receive a set of selectable AI/ML models associated with an operation of a vehicle-based device, the selectable AI/ML models having different sizes and being trained to provide assistance in the operation. The program instructions comprise program instructions to apply, in association with performance of the operation, a first AI/ML model of the set of selectable AI/ML models. The program instructions comprise program instructions to apply, in association with performance of the operation and based at least in part on performance of the first AI/ML model, a second AI/ML model of the set of selectable AI/ML models.

In some implementations, a system comprises one or more devices configured to receive a set of selectable AI/ML models associated with an automated-driving-based operation of a vehicle-based device, the selectable AI/ML models having different sizes and being trained to provide assistance in the operation. The one or more devices are configured to apply, in association with performance of the operation, a first AI/ML model of the set of selectable AI/ML models. The one or more devices are configured to identify one or more performance metrics of the second AI/ML model. The one or more devices are configured to apply, in association with the one or more performance metrics of the first AI/ML model, a second AI/ML model of the set of selectable AI/ML models.

### BRIEF DESCRIPTION OF THE DRAWINGS

FIGS. 1A-1H are diagrams of an example implementation of performance-based model se-selection described herein.

FIG. 2 is a diagram of an example implementation of performance-based model se-selection described herein.

FIG. 3 is a diagram of an example computing environment in which systems and/or methods described herein may be implemented.

FIG. 4 is a diagram of example components of one or more devices of FIGS. 1 and 2.

FIGS. 5-7 are flowcharts of example processes associated with performance-based model se-selection.

### DETAILED DESCRIPTION

The following detailed description of example implementations refers to the accompanying drawings. The same reference numbers in different drawings may identify the same or similar elements.

Applications of the present disclosure include automated or automatically-assisted operation of devices. Such devices may include vehicles, such as in automated driving of vehicles, equipment such as elevators and escalators, robots, and other equipment used in an automated or semi-automated manner. If such devices make use of artificial intelligence (AI) or machine learning (ML) models (collectively, AI/ML models) for their operation, then they can also make use of the techniques presented herein. In this description, automated driving is used as merely an example application of the described techniques, but is not to be understood to be the only application of the techniques described.

Automated driving (AD) includes autonomous, semi-autonomous, and assisted driving, and technical capabilities required for enabling these. AI/ML models may be used for tasks in automated driving. For example, AI/ML models may include traffic lane identification, assisted or automated braking, pedestrian or other obstruction detection, or control (e.g., steering or navigation) of the vehicle itself in a road environment. AI/ML models can also be used within vehicles for infotainment tasks.

As more AI/ML models are deployed inside vehicles, the AI/ML models may share computing resources with a limited capacity (e.g., GPU capacity). Some AI/ML models may be associated with AD operations, infotainment, or virtual assistants, among other examples.

Computing resources may be shared for all of these AI/ML models, causing the AI/ML models to compete for resources and potentially causes operational errors.

AI/ML models using limited resources may have relative high standards for latency (e.g., inference time) and precision of quality of an output. For example, an AD operation may have a threshold time and a threshold error rate for object detection. Failure of either may cause significant harm. However, allocating all computing resources to object detection may degrade performance of other AI/ML models operating within the vehicle.

To allow for sharing resources, AI/ML models may tradeoff between fast inference time (e.g., latency) and output quality. While better AI/ML models suffer less quality degradation to provide faster inference times, there is still some amount of quality degradation associated with providing faster inference time.

In addition to competition for computing resources and balancing latency and accuracy, AI/ML models for AD may be improved if customized for the vehicle on which it is to be used. Driving styles may differ among a driving population, road conditions may differ and encountered drivers and pedestrians may differ. To account for this difference, AI/ML models may be fine-tuned for used by individual vehicles on which it is to be used.

Usage requirements of AI/ML models for AD may vary dynamically as a function of) other AI/ML model models running in the vehicle and effectiveness in experienced environment of those deployed AI/ML models for AD.

In some aspects described herein, a device (e.g., a vehicle-based device, among other examples) may receive a set of selectable AI/ML models associated with an operation of the device. For example, the device may receive a small, a medium, and a large AI/ML model that are selectable (e.g., at alternatives) for performance of a particular operation, such as an AD operation. The device may select a first of the set of selectable AI/ML models to initially apply for the operation. During usage of the first AI/ML model, the device may identify performance metrics (e.g., key performance indicators (KPIs)) associated with the first AI/ML model. Based at least in part on the performance metrics, the device may apply a second of the AI/ML models to perform the operation instead of the first AI/ML model.

In this way, the device may select and re-select AI/ML models for an operation, with the different selectable AI/ML models being available at the device without requesting a new AI/ML model from a remote computing device or retraining the first AI/ML model to generate the second AI/ML model. Based at least in part on the device being configured to re-select an AI/ML model for an operation, the device may instantiate an appropriate AI/ML model for a particular environment or circumstance. For example, the device may select a larger model (e.g., having more model parameters) to improve accuracy relative to a smaller model. Alternatively, the device may select a smaller model (e.g., having fewer parameters) to improve latency relative to a larger model. In some aspects, the device may use a smaller model to reduce consumption of computing resources for the operation based at least in part on a demand for the computing resources from another AI/ML model with a higher priority (e.g., an AD-related operation, among other examples). This may improve performance of the device by supporting prioritization among AI/ML models and prioritization of metrics (e.g., latency or accuracy) based at least in part on circumstances or an environment.

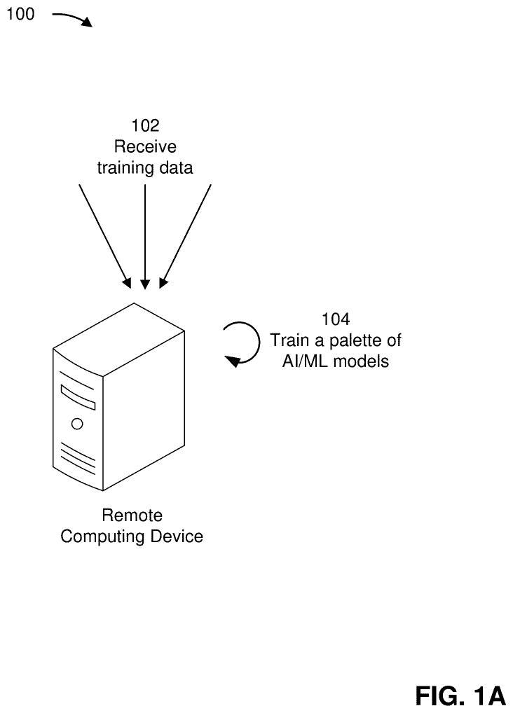

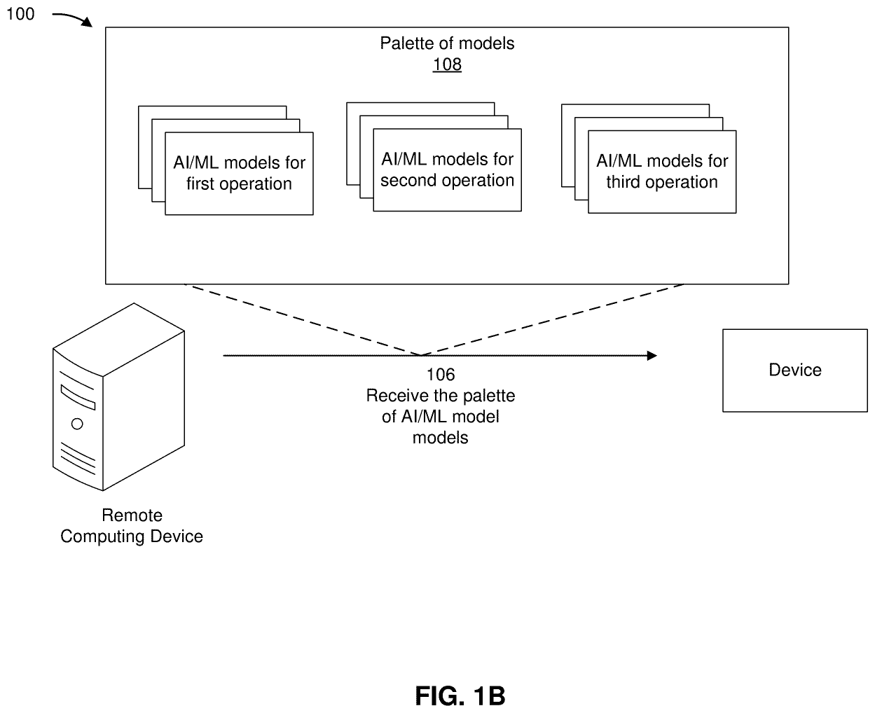

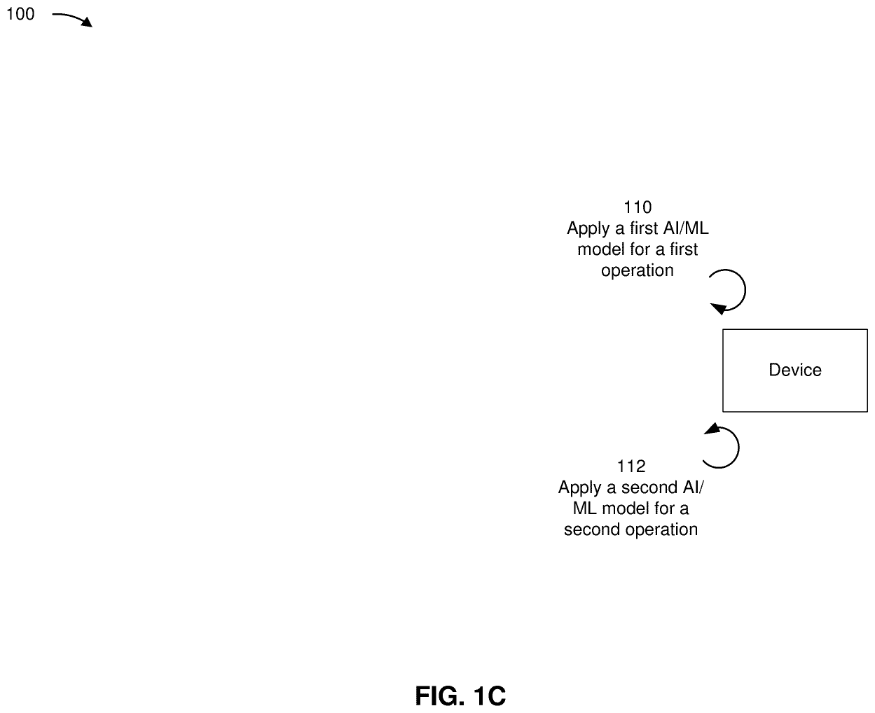

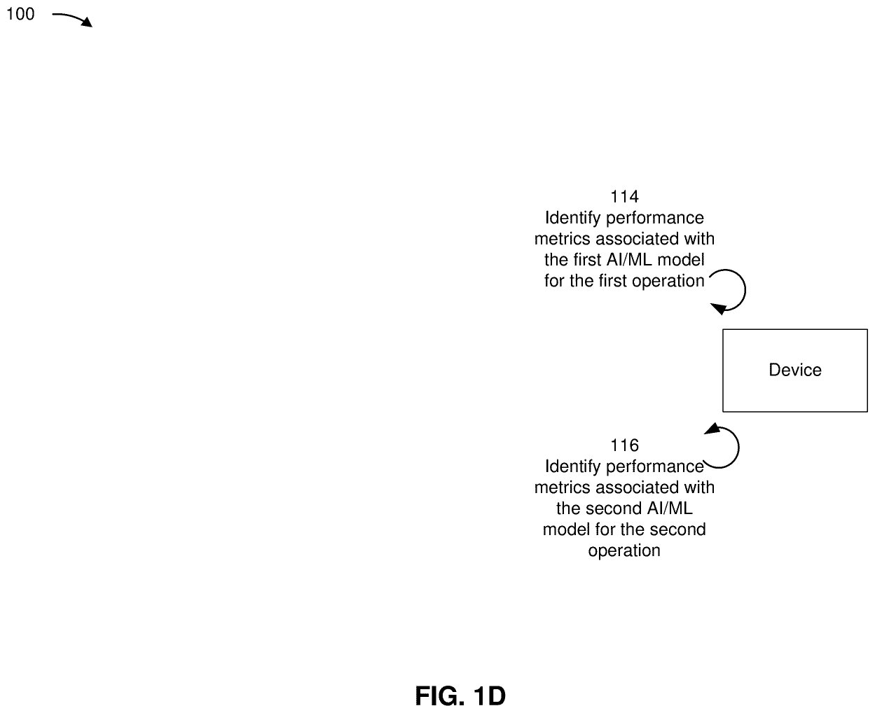

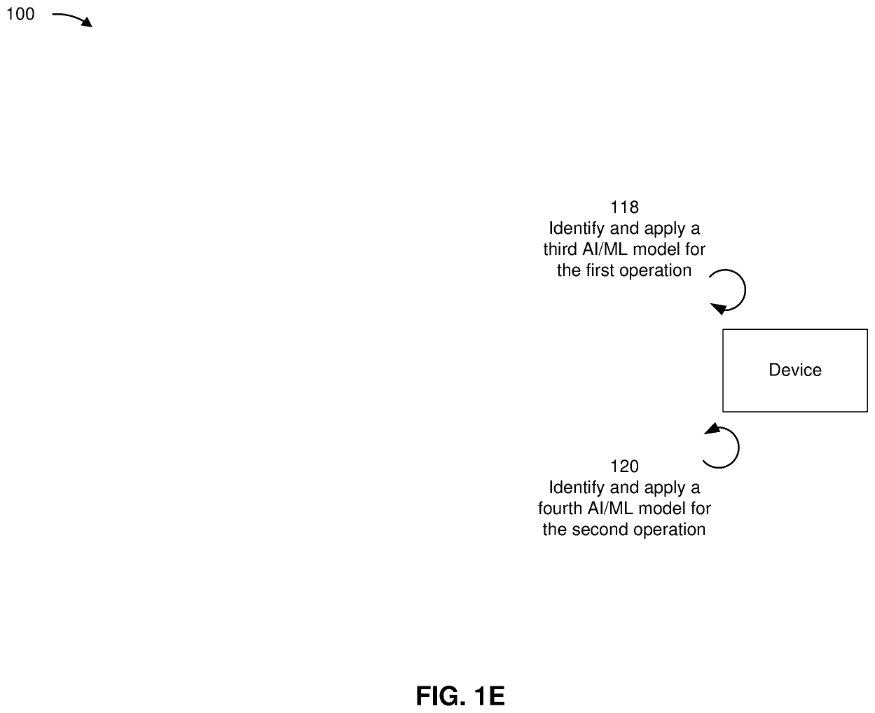

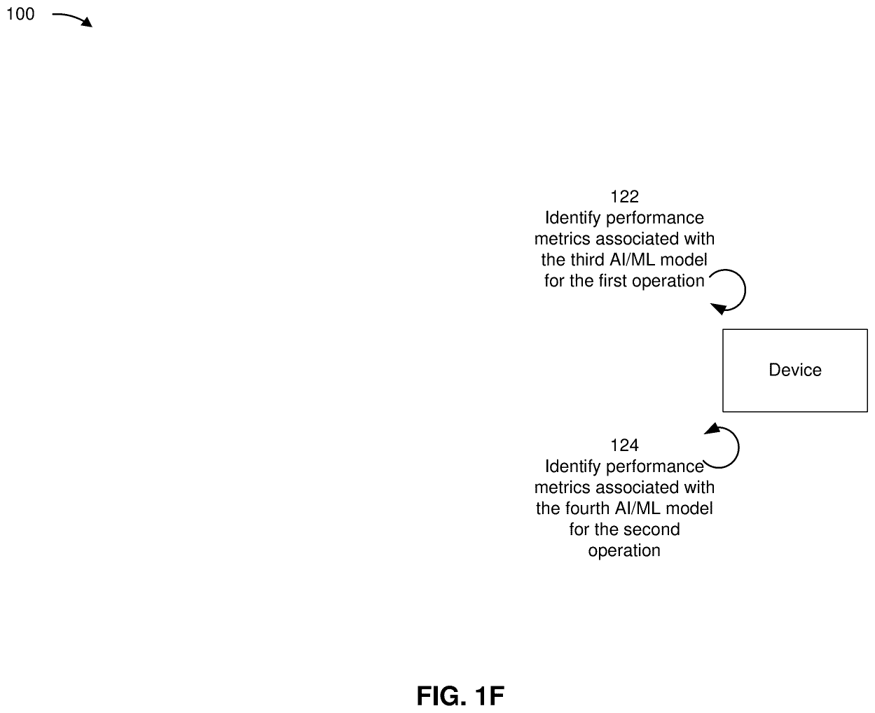

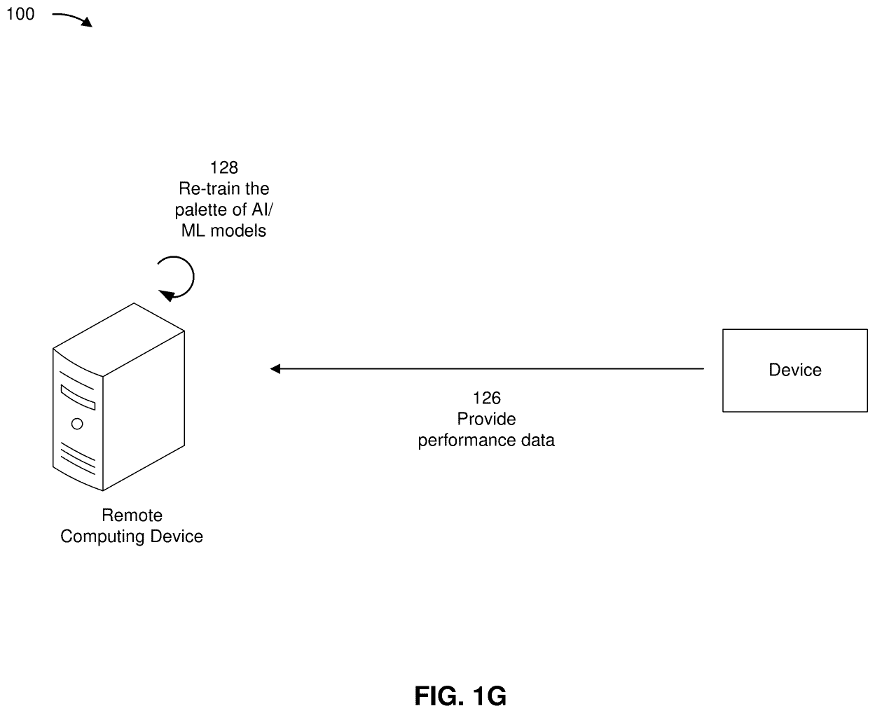

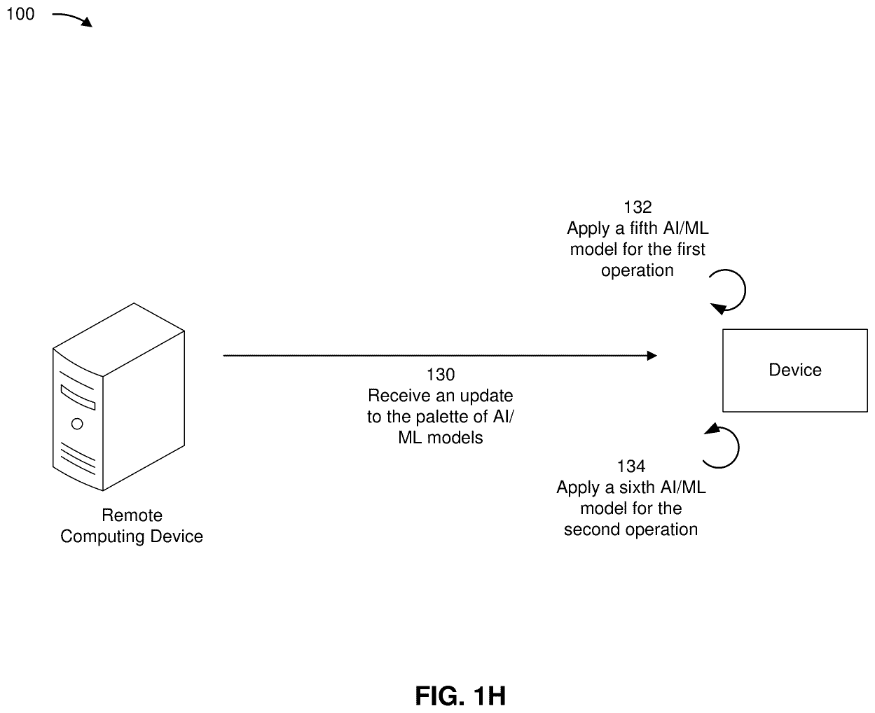

FIGS. 1A-1H are diagrams of an example implementation 100 of performance-based model se-selection described herein. As shown in FIGS. 1A-1H, example implementation 100 includes a remote computing device and a device that communicate in support of application of AI/ML models on the device and generation or retraining of the AI/ML models on the remote computing device. Although described in context of an AD model or a vehicle-based device, the AI/ML model may be associated with any AI/ML model used by the device (e.g., associated with latency and accuracy metrics) and the device may be a transportation device or an object-recognition device, among other examples.

As shown in FIG. 1A, and by reference number 102, the remote computing device may receive training data. In some aspects, the remote computing device may receive the training data from the device, multiple devices in a geographical region associated with the device, or multiple geographical regions. In some aspects, the training data may include data inputs associated with performance of an operation (e.g., internal telemetry data or external conditions, among other examples), a decision by the AI/ML model being trained, and performance metrics associated with the decision. For example, performance metrics in the vehicle application may include data associated with frequency of use, fuel consumption, trip parameters, or per-trip parameters, among other examples. Per-trip parameters may include cruising velocity, acceleration, braking velocity, acceleration, steering wheel position over time, tire pressure, mileage, external shocks, external weather, altitude over time, and information technology (IT) data such as graphical processing unit (GPU) usage percentages over time or memory usage over time or model runtime latency.

As shown by reference number 104, the remote computing device may train a palette of AI/ML models. For example, the palette of AI/ML models may include multiple options for selection in associated with an operation, such as object detection, at the device.

As shown in FIG. 1B, and by reference number 106, the device may receive, and the remote computing device may provide, the palette of AI/ML models, for example, of different sizes and latency and memory usage. In some aspects, the palette of AI/ML models may include regional-based AI/ML models, device-specific AI/ML models, or universal models, among other examples.

As shown by reference number 108, the palette of AI/ML models may include a set of selectable AI/ML models for a first operation, a set of selectable AI/ML models for a second operation, and a set of selectable AI/ML models for a first operation. In some aspects, the palette of AI/ML models may include any number of selectable models for each included operation-based set of AI/ML models. Additionally, or alternatively, the palette of models may include any number of sets of AI/ML model models associated with any number of operations.

As shown in FIG. 1C, and by reference number 110, the device may apply a first AI/ML model for the first operation. For example, the device may select one AI/ML model of the set of AI/ML models of the palette of AI/ML models that is associated with the first operation.

As shown by reference number 112, the device may apply a second AI/ML model for the second operation. For example, the device may select one AI/ML model of the set of AI/ML models of the palette of AI/ML models that is associated with the second operation. Although described in context of a first operation and second operation and associated AI/ML models, the operations described in connection with FIGS. 1A-1H may include only one operation and associated AI/ML models, or may include two or more operations and associated AI/ML models.

As shown in FIG. 1D, and by reference number 114, the device may identify performance metrics associated with the first AI/ML model for the first operation. For example, the device may identify latency or accuracy of decisions of the first AI/ML model associated with performance of the first operation. Additionally, or alternatively, the device my identify outcomes associated with performance of the device when using the first AI/ML model for the first operation, such as fuel consumption, trip parameters, and per-trip parameters such as cruising velocity, acceleration, braking velocity, acceleration, steering wheel position over time, tire pressure, mileage, external shocks, external weather, altitude over time, or IT data such as GPU usage over time or memory usage over time, among other examples.

As shown by reference number 116, the device may identify performance metrics associated with the second AI/ML model for the second operation, as described relative to the first AI/ML model and the first operation in connection with reference number 114.

As shown in FIG. 1E, and by reference number 118, the device may identify an apply a third AI/ML model for the first operation. For example, the device may determine that the third AI/ML model has a more appropriate size than the first AI/ML model for performing the first operation in current conditions. In some aspects, the device may replace the first AI/ML model with the third AI/ML model based at least in part on the performance metrics indicating poor latency (e.g., too slow in decision-making), poor accuracy (e.g., failing to satisfy a threshold), or consumption of too many computing resources when using the first AI/ML model. In these examples, the device may select the third AI/ML model to apply based at least in part on a likelihood to improve the performance metric relative to the first AI/ML model.

As shown by reference number 120, the, the device may identify an apply a fourth AI/ML model for the second operation, as described relative to the third AI/ML model and the first operation in connection with reference number 118.

As shown by reference number 122, the device may identify performance metrics associated with the third AI/ML model for the first operation, as described relative to the first AI/ML model and the first operation in connection with reference number 114.

As shown by reference number 124, the device may identify performance metrics associated with the fourth AI/ML model for the second operation, as described relative to the first AI/ML model and the first operation in connection with reference number 114.

In some aspects, the device may replace the third AI/ML model or the fourth AI/ML model with a different AI/ML model based at least in part on the performance metrics as described in connection with reference numbers 118 and 119. In some aspects, the device may replace the third AI/ML model or the fourth AI/ML model with additional AI/ML models, or may revert back to the first AI/ML model or the second AI/ML model.

As shown in FIG. 1G, and by reference number 126, the device may provide performance data to the remote computing device. For example, the device may provide the performance metrics or a reduced set of the performance metrics determined to be useful for retraining the palette of AI/ML models.

As shown by reference number 128, the remote computing device may re-train the palette of AI/ML models. For example, the remote computing device may provide the performance data as additional inputs and evaluation data for re-training one or more AI/ML models of the palette of AI/ML models.

As shown in FIG. 1H, and by reference number 130, the device may receive, and the remote computing device may provide, an update to the palette of AI/ML models. In some aspects, the update to the palette of AI/ML models may include updates to individual AI/ML models, may include new AI/ML models, or may remove previously-provided AI/ML models, among other examples.

As shown by reference number 132, the device may apply a fifth AI/ML model for the first operation. The fifth AI/ML model may be included in the update to the palette of AI/ML models provided by the remote computing device. Similarly, as shown by reference number 134, the device may apply a sixth AI/ML model for the second operation.

As indicated above, FIGS. 1A-1H are provided as an example. Other examples may differ from what is described with regard to FIGS. 1A-1H. The number and arrangement of devices shown in FIGS. 1A-1H are provided as an example.

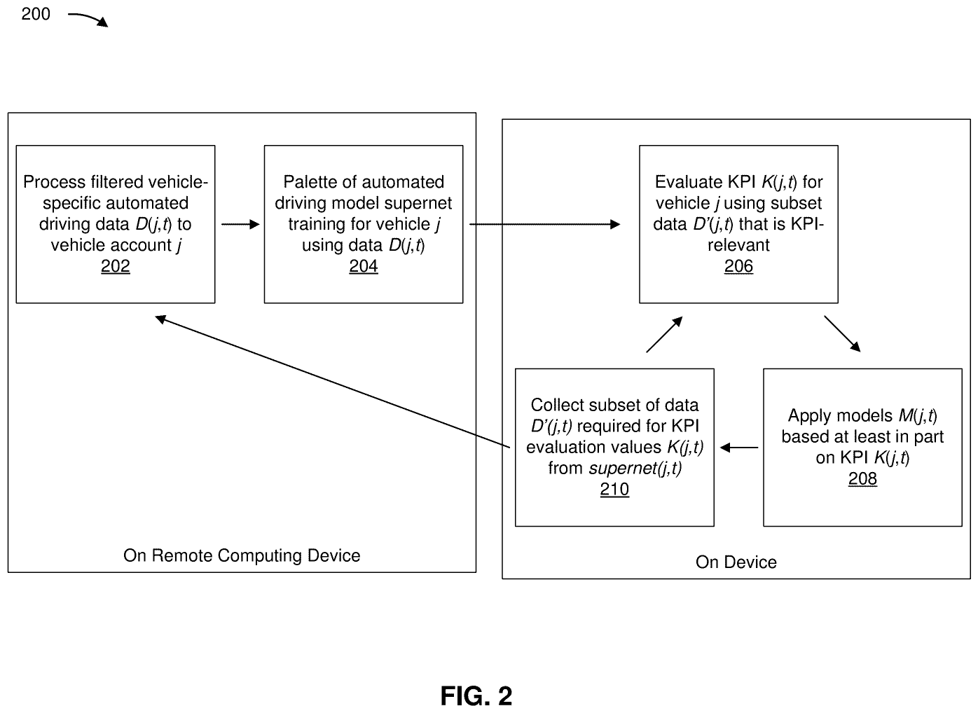

FIG. 2 is a diagram of an example implementation 200 of performance-based model se-selection described herein. Example implementation 200 may be associated with the example 100 of FIGS. 1A-1H. FIG. 2 shows operations performed on a remote computing device and operations performed on a device.

As shown in FIG. 2, and by reference number 202, the remote computing device may process filtered vehicle-specific AD data D(j,t) (for vehicle j over time period t) to vehicle account j. For example, the remote computing device may collect, filter, and transmit filtered vehicle-specific AD data to vehicle-account j on the cloud. The AD data may include internet of things (IoT) data, driving data, or metrics-related data that are collected and filtered on the vehicle. The filtered set may be transmitted to the vehicle cloud storage account on a periodic basis or when significant distribution changes are identified.

D(j,t) may include all data, internal telemetry data and external conditions data, collected on vehicle j at time period t. For example, D(j,t) may include data or indications associated with frequency of use, fuel consumption, trip parameters, and per-trip parameters including cruising velocity, acceleration, braking velocity, acceleration, steering wheel position over time, tire pressure, mileage, external shocks, external weather, altitude over time, or IT data such as GPU usage percentage over time or memory usage or model latency over time.

D(j,t) may be filtered into a larger subset for periodic (e.g. monthly) model retraining, and a smaller subset for (e.g. nightly) metrics evaluation. D(j,t) may be referred to as the larger subset to be sent to the vehicle account on the cloud for the given period (e.g. month) t that is larger than a subset of the data D′(j,t) described herein. This subset includes appropriate summary statistics or a histogram of data types. For example, a noisy data type may be summarized by a median and other data types may be summarized by a mean or standard deviation, or a histogram, depending on properties of a data sequence over time.

As shown by reference number 204, the remote computing device may generate, and send to the device, a palette of model supernet training for vehicle j using data D(j,t). In some aspects, supernet model training may include supernet training of a palette of an model for vehicle j using data D(j,t). Supernet training may use a semi-supervised approach. Unlabeled data from the user data D(j,t) may augment company-provided labeled data. This process may be performed on the same periodic or as-needed basis as the data upload (e.g., monthly). For periodic re-training, new data from the vehicle may not be annotated. Hence the loss function for the supernet model training may include the vehicle (not annotated data) defined as “unlab.” This supernet training process may be updated periodically, such as monthly, using the known labeled data and the most recent unlabeled data from the vehicle.

As shown by reference number 206, the device may evaluate KPI K(j,t) for vehicle j using a subset of data D′(j,t) that is KPI-relevant. Using the subset of the vehicle data D(j,t) which is relevant for (more frequent) KPI evaluation, D′(j,t), the device may evaluate the KPI on model performance, both in terms of IT resource capacity (e.g., IT metrics including onboard memory, CPU/GPU usage, or inference latency) and in terms of quality performance. Examples of KPI metrics for quality performance that do not require annotation may include no-excessive-sudden-braking, smooth acceleration/deceleration, or lack of swerving/smooth turning, among other examples.

The KPI calculation may use as input the threshold-based indicator variables of the above metrics, and combine them into a single IT metric (e.g., IT metric is green if all of the IT metrics threshold-based indicator variables are 0, orange if an inference latency indicator is 1 and the other two are 0, and red otherwise). The performance quality threshold-based indicator variables may be combined in an analogous manner.

D′(j,t) may be referred to as the smaller filtered set used for calculation of the KPI metrics on the (e.g. nightly) frequency. D′(j,t) may be limited to those data types that can be used to provide an assessment of IT load and quality of the model output without requiring annotations of, for example, objects detected.

For example, D′(j,t) may include, for example, IT metrics threshold-based indicator variables on an onboard GPU and CPU load over time, onboard memory utilization over time, inference latencies (e.g., depending on the operating system or environment). D′(j,t) may further include information associated with performance telemetry including threshold-based indicator variables on acceleration, deceleration, turning, swerving and braking, among other examples (e.g., where a threshold-based indicator is 0 if the metric is less than the threshold and 1 otherwise).

As shown by reference number 208, the device may apply AI/ML models M(j,t) based at least in part on KPI K(j,t). For example, the device may instantiate M(j,t). Guided by KPI K(j,t) from supernet(j,t) and instantiate an appropriate-sized model to improve performance. For example, if an IT-usage KPI shows excessive resource consumption or poor latency, then the device may select a smaller AI/ML model with a smaller size. If a quality-performance KPI shows inferior quality performance values, the device may select an AI/ML model with a larger size. If model selection differs from a current model, then deploy or update the new model on the device (e.g., vehicle j).

When the overall IT metric indicator is GREEN but the performance quality indicator is ORANGE or RED, then the device may select and update the model with a higher-performance model. When the overall IT metric indicator is RED and a performance quality indicator is GREEN, the device may replace the model with a lower resource-consuming model. Other cases may be handled analogously. In some cases, such as GREEN-GREEN, no update may be made to the model.

If an IT resource is insufficient for a current workload and quality is insufficient, the device may alert a user (e.g., a driver) to reduce usage of non-essential AI tools (e.g., a conversational assistant). If the IT resource insufficiency or the quality insufficiency satisfies a threshold, the device may hard-block the non-essential AI services or inform a user to service the device.

As shown by reference number 210, the device may collect, and send to the remote computing device, a subset of data D′(j,t) associated with KPI evaluation values K(j,t) from supernet(j,t). In some aspects, the subset of data associated with computing the KPI may be pre-programmed into the device. These may include the data associated with evaluating IT and quality performance (e.g., on a daily basis). This subset of data, D′(j,t) may be transmitted to a vehicle cloud account on a nightly basis, for example.

As indicated above, FIG. 2 is provided as an example. Other examples may differ from what is described with regard to FIG. 2. The number and arrangement of devices shown in FIG. 2 are provided as an example.

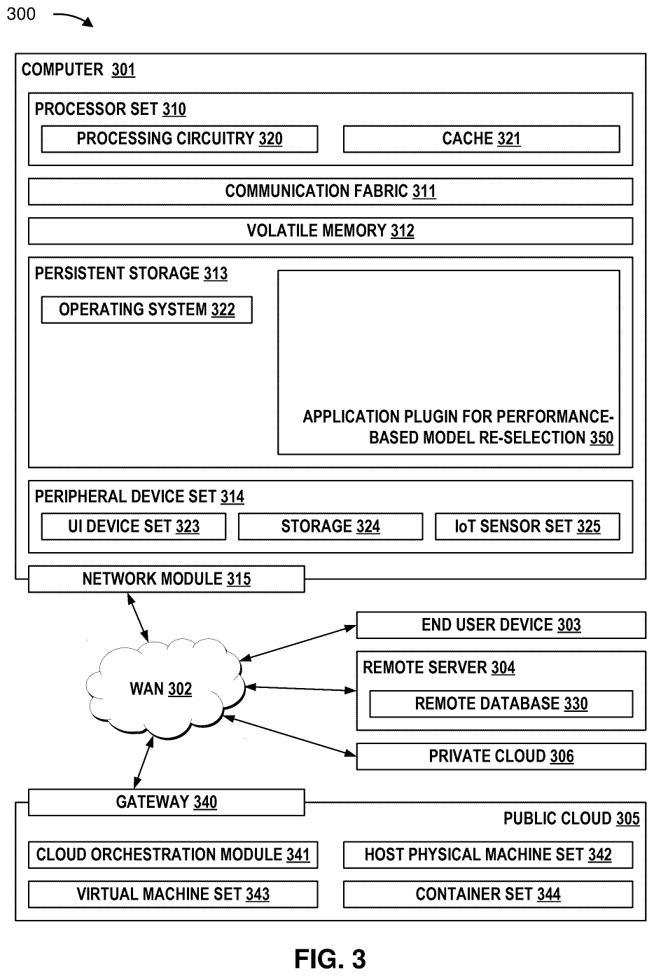

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application plugin for performance-based model re-selection 350. In addition to application plugin for performance-based model re-selection 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for performance-based model re-selection 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310.

Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for performance-based model re-selection 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for performance-based model re-selection 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

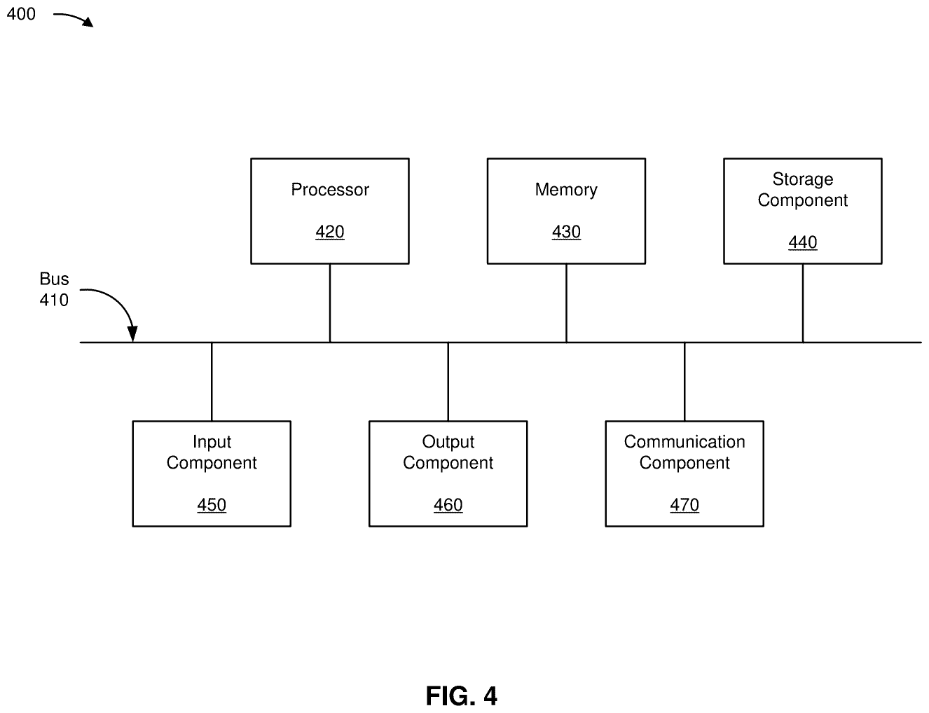

FIG. 4 is a diagram of example components of a device 400, which may correspond to the device of FIGS. 1A-2 or the remote computing device, among other examples. In some implementations, the computing device or remote computing device may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

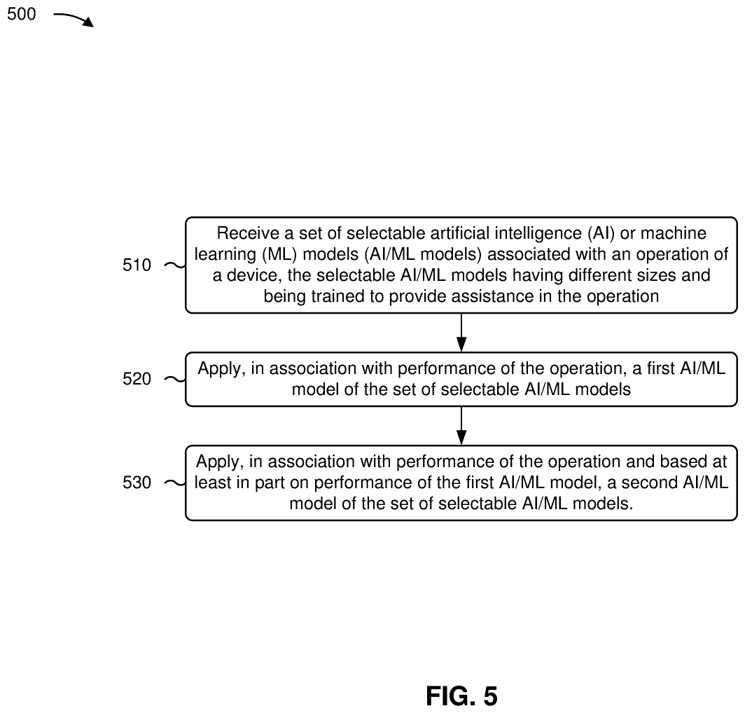

FIG. 5 is a flowchart of an example process 500 associated with performance-based model re-selection brief description of the drawings. In some implementations, one or more process blocks of FIG. 5 may be performed by a computing device (e.g., the device or the remote computing device of FIGS. 1A-2). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving a set of selectable AI/ML models associated with an operation of a device, the selectable AI/ML models having different sizes and being trained to provide assistance in the operation (block 510). For example, the device may receive a set of selectable AI/ML models associated with an operation of a device, the selectable AI/ML models having different sizes and being trained to provide assistance in the operation, as described above.

As further shown in FIG. 5, process 500 may include applying, in association with performance of the operation, a first AI/ML model of the set of selectable AI/ML models (block 520). For example, the device may apply, in association with performance of the operation, a first AI/ML model of the set of selectable AI/ML models, as described above.

As further shown in FIG. 5, process 500 may include applying, in association with performance of the operation and based at least in part on performance of the first AI/ML model, a second AI/ML model of the set of selectable AI/ML models. (block 530). For example, the device may apply, in association with performance of the operation and based at least in part on performance of the first AI/ML model, a second AI/ML model of the set of selectable AI/ML models., as described above.

Process 500 may include additional implementations, such as any single implementation or any combination of implementations described below and/or in connection with one or more other processes described elsewhere herein.

In a first implementation, process 500 includes sending, to a remote computing device, performance metrics associated with the first AI/ML model or the second AI/ML model to an application server, and receiving an update to the set of selectable AI/ML models.

In a second implementation, alone or in combination with the first implementation, the update to the set of selectable AI/ML models comprises updating AI/ML models that are re-trained using the performance metrics, or one or more AI/ML models having different sizes than the selectable AI/ML models.

In a third implementation, alone or in combination with one or more of the first and second implementations, applying the second AI/ML model comprises applying the second AI/ML model before receiving the update to the set of selectable AI/ML models.

In a fourth implementation, alone or in combination with one or more of the first through third implementations, process 500 includes identifying one or more performance metrics of the second AI/ML model, and applying a third AI/ML model based at least in part on the one or more performance metrics of the second AI/ML model.

In a fifth implementation, alone or in combination with one or more of the first through fourth implementations, the third AI/ML model comprises, the first AI/ML model, or an AI/ML model having a size that is different from the first AI/ML model and the second AI/ML model.

In a sixth implementation, alone or in combination with one or more of the first through fifth implementations, applying the second AI/ML model based at least in part on performance of the first AI/ML model comprises identifying one or more performance metrics of the first AI/ML model, and identifying the second AI/ML model as being expected to improve at least one of the one or more performance metrics.

In a seventh implementation, alone or in combination with one or more of the first through sixth implementations, the one or more performance metrics comprise one or more of a latency metric, an accuracy metric, consumption of computing resources associated with use of the first AI/ML model.

In an eighth implementation, alone or in combination with one or more of the first through seventh implementations, the first AI/ML model is associated with a first latency that is slower than a second latency associated with the second AI/ML model, wherein the first AI/ML model is associated with a first accuracy that is less accurate than a second accuracy level associated with the second AI/ML mode, or wherein the first AI/ML model is associated with a first amount of computing resources that is greater than a second amount of computing resources associated with the second AI/ML model.

In a ninth implementation, alone or in combination with one or more of the first through eighth implementations, the operation of the device is associated with an automated driving operation, or wherein the operation of the device is associated with a non-driving operation.

In a tenth implementation, alone or in combination with one or more of the first through ninth implementations, process 500 includes receiving an additional set of additional selectable AI/ML models associated with an additional operation of the device, the additional selectable AI/ML models having different sizes and being trained to provide assistance in the additional operation, and applying a third AI/ML model of the additional set of additional selectable AI/ML models in association with performance of the additional operation, In an eleventh implementation, alone or in combination with one or more of the first through tenth implementations, process 500 includes applying, in association with performance of the additional operation, a fourth AI/ML model of the additional set of additional selectable AI/ML models and based at least in part on performance of the third AI/ML model or application of the second AI/ML model.

In a twelfth implementation, alone or in combination with one or more of the first through eleventh implementations, the applying the second AI/ML model in association with performance of the operation is based at least in part on application of the third AI/ML model of the device in association with the additional operation.

In a thirteenth implementation, alone or in combination with one or more of the first through twelfth implementations, the device comprises one or more of a vehicle-based device, a transportation device, or an object-recognition device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

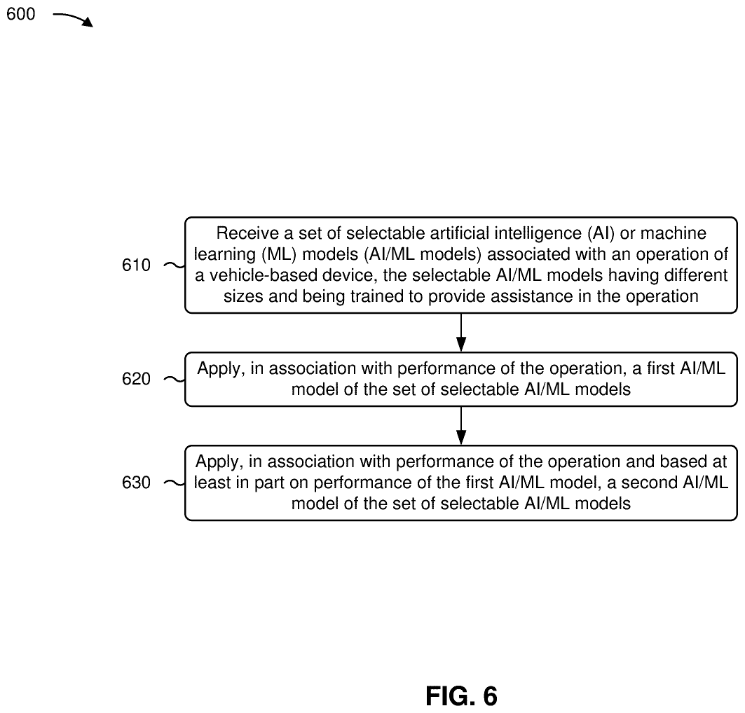

FIG. 6 is a flowchart of an example process 600 associated with performance-based model re-selection brief description of the drawings. In some implementations, one or more process blocks of FIG. 6 may be performed by a computing device (e.g., the device or the remote computing device of FIGS. 1A-2). Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include receiving a set of selectable AI/ML models associated with an operation of a vehicle-based device, the selectable AI/ML models having different sizes and being trained to provide assistance in the operation (block 610). For example, the device may receive a set of selectable AI/ML models associated with an operation of a vehicle-based device, the selectable AI/ML models having different sizes and being trained to provide assistance in the operation, as described above.

As further shown in FIG. 6, process 600 may include applying, in association with performance of the operation, a first AI/ML model of the set of selectable AI/ML models (block 620). For example, the device may apply, in association with performance of the operation, a first AI/ML model of the set of selectable AI/ML models, as described above.

As further shown in FIG. 6, process 600 may include applying, in association with performance of the operation and based at least in part on performance of the first AI/ML model, a second AI/ML model of the set of selectable AI/ML models (block 630). For example, the device may apply, in association with performance of the operation and based at least in part on performance of the first AI/ML model, a second AI/ML model of the set of selectable AI/ML models, as described above.

Process 600 may include additional implementations, such as any single implementation or any combination of implementations described below and/or in connection with one or more other processes described elsewhere herein.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

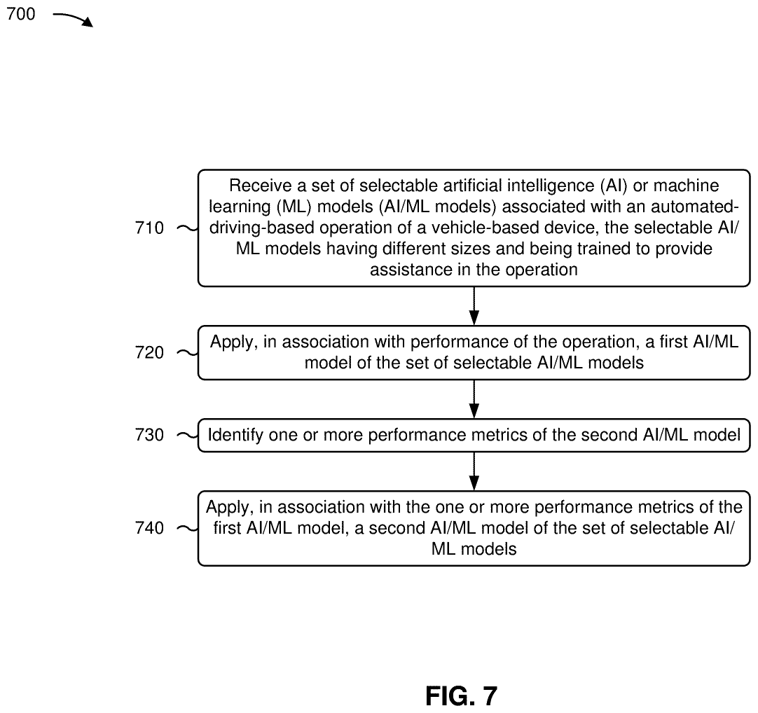

FIG. 7 is a flowchart of an example process 700 associated with performance-based model re-selection brief description of the drawings. In some implementations, one or more process blocks of FIG. 7 may be performed by a computing device (e.g., the device or the remote computing device of FIGS. 1A-2). Additionally, or alternatively, one or more process blocks of FIG. 7 may be performed by one or more components of device 400, such as processor 420, memory 430, storage component 440, input component 450, output component 460, and/or communication component 470.

As shown in FIG. 7, process 700 may include receiving a set of selectable AI/ML models associated with an automated-driving-based operation of a vehicle-based device, the selectable AI/ML models having different sizes and being trained to provide assistance in the operation (block 710). For example, the device may receive a set of selectable AI/ML models associated with an automated-driving-based operation of a vehicle-based device, the selectable AI/ML models having different sizes and being trained to provide assistance in the operation, as described above.

As further shown in FIG. 7, process 700 may include applying, in association with performance of the operation, a first AI/ML model of the set of selectable AI/ML models (block 720). For example, the device may apply, in association with performance of the operation, a first AI/ML model of the set of selectable AI/ML models, as described above.

As further shown in FIG. 7, process 700 may include identifying one or more performance metrics of the second AI/ML model (block 730). For example, the device may identify one or more performance metrics of the second AI/ML model, as described above.

As further shown in FIG. 7, process 700 may include applying, in association with the one or more performance metrics of the first AI/ML model, a second AI/ML model of the set of selectable AI/ML models (block 740). For example, the device may apply, in association with the one or more performance metrics of the first AI/ML model, a second AI/ML model of the set of selectable AI/ML models, as described above.

Process 700 may include additional implementations, such as any single implementation or any combination of implementations described below and/or in connection with one or more other processes described elsewhere herein.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a set of selectable artificial intelligence (AI) or machine learning (ML) models (AI/ML models) associated with an operation of a device, the selectable AI/ML models having different sizes and being trained to provide assistance in the operation;
applying, in association with performance of the operation, a first AI/ML model of the set of selectable AI/ML models; and
applying, in association with performance of the operation and based at least in part on performance of the first AI/ML model, a second AI/ML model of the set of selectable AI/ML models.

2. The method of claim 1, further comprising:
sending, to a remote computing device, performance metrics associated with the first AI/ML model or the second AI/ML model to an application server; and
receiving an update to the set of selectable AI/ML models.

3. The method of claim 2, wherein the update to the set of selectable AI/ML models comprises:
updated AI/ML models that are re-trained using the performance metrics, or one or more AI/ML models having different sizes than the selectable AI/ML models.

4. The method of claim 2, wherein applying the second AI/ML model comprises:
applying the second AI/ML model before receiving the update to the set of selectable AI/ML models.

5. The method of claim 1, further comprising:
identifying one or more performance metrics of the second AI/ML model; and
applying a third AI/ML model based at least in part on the one or more performance metrics of the second AI/ML model.

6. The method of claim 4, wherein the third AI/ML model comprises;
the first AI/ML model, or
an AI/ML model having a size that is different from the first AI/ML model and the second AI/ML model.

7. The method of claim 1, wherein applying the second AI/ML model based at least in part on performance of the first AI/ML model comprises:
identifying one or more performance metrics of the first AI/ML model; and
identifying the second AI/ML model as being expected to improve at least one of the one or more performance metrics.

8. The method of claim 6, wherein the one or more performance metrics comprise one or more of:
a latency metric,
an accuracy metric, or
consumption of computing resources associated with use of the first AI/ML model.

9. The method of claim 1, wherein the first AI/ML model is associated with a first latency that is slower than a second latency associated with the second AI/ML model,
wherein the first AI/ML model is associated with a first accuracy that is less accurate than a second accuracy level associated with the second AI/ML mode, or
wherein the first AI/ML model is associated with a first amount of computing resources that is greater than a second amount of computing resources associated with the second AI/ML model.

10. The method of claim 1, wherein the operation of the device is associated with an automated driving operation, or
wherein the operation of the device is associated with a non-driving operation.

11. The method of claim 1, further comprising:
receiving an additional set of additional selectable AI/ML models associated with an additional operation of the device, the additional selectable AI/ML models having different sizes and being trained to provide assistance in the additional operation; and
applying a third AI/ML model of the additional set of additional selectable AI/ML models in association with performance of the additional operation.

12. The method of claim 11, further comprising:
applying, in association with performance of the additional operation, a fourth AI/ML model of the additional set of additional selectable AI/ML models and based at least in part on performance of the third AI/ML model or application of the second AI/ML model.

13. The method of claim 11, wherein the applying the second AI/ML model in association with performance of the operation is based at least in part on application of the third AI/ML model of the device in association with the additional operation.

14. The method of claim 11, wherein the device comprises one or more of:
a vehicle-based device,
a transportation device, or
an object-recognition device.

15. A computer program product comprising:
one or more computer readable storage media, and program instructions collectively stored on the one or more computer readable storage media, the program instructions comprising:
program instructions to receive a set of selectable artificial intelligence (AI) or machine learning (ML) models (AI/ML models) associated with an operation of a vehicle-based device, the selectable AI/ML models having different sizes and being trained to provide assistance in the operation;
program instructions to apply, in association with performance of the operation, a first AI/ML model of the set of selectable AI/ML models; and
program instructions to apply, in association with performance of the operation and based at least in part on performance of the first AI/ML model, a second AI/ML model of the set of selectable AI/ML models.

16. The computer program product of claim 15, wherein the program instructions comprise:
program instructions to send, to a remote computing device, performance metrics associated with the first AI/ML model or the second AI/ML model to an application server; and
program instructions to receive an update to the set of selectable AI/ML models.

17. The computer program product of claim 16, wherein, to apply the second AI/ML model, the program instructions comprises:
program instructions to apply the second AI/ML model before receiving the update to the set of selectable AI/ML models.

18. A system comprising:
one or more devices configured to:
receive a set of selectable artificial intelligence (AI) or machine learning (ML) models (AI/ML models) associated with an automated-driving-based operation of a vehicle-based device, the selectable AI/ML models having different sizes and being trained to provide assistance in the operation;
apply, in association with performance of the operation, a first AI/ML model of the set of selectable AI/ML models;
identify one or more performance metrics of the second AI/ML model; and
apply, in association with the one or more performance metrics of the first AI/ML model, a second AI/ML model of the set of selectable AI/ML models.

19. The system of claim 18 wherein the one or more performance metrics comprise one or more of:
a latency metric,
an accuracy metric,
consumption of computing resources associated with use of the first AI/ML model.

20. The system of claim 18, wherein the first AI/ML model is associated with a first latency that is slower than a second latency associated with the second AI/ML model,
wherein the first AI/ML model is associated with a first accuracy that is less accurate than a second accuracy level associated with the second AI/ML mode, or
wherein the first AI/ML model is associated with a first amount of computing resources that is greater than a second amount of computing resources associated with the second AI/ML model.
